(19) United States
(12) Patent Application Publication
(10) Pub. No.: US 2009/0054261 A1
(43) Pub. Date: Feb. 26, 2009

(54) METHOD

(75) Inventors: Ian Hughes, Essex (GB); Brian Herbert Warrington, Essex (GB); Yuk Fan Wong, Essex (GB)

Correspondence Address: GLAXOSMITHKLINE;CORPORATE INTELLECTUAL PROPERTY, MAI B482, FIVE MOORE DR., PO BOX 13398, RESEARCH TRIANGLE PARK, NC, 27709-3398, US

(73) Assignee: GLAXO GROUP LIMITED, Middlesex (GB)

(21) Appl. No.: 11/576,913

(22) PCT Filed: Oct. 6, 2005
(86) PCT No.: PCT/GB2005/003850

§ 371 Date: Oct. 23, 2008

(30) Foreign Application Priority Data
Oct. 7, 2004 (GB) 0422378.0

(51) Int. Cl. C40B 30/10

(52) U.S. Cl. 506/12

(57) ABSTRACT

A method of controlling a system having a microfluidic channel structure in which fluids are able to interact to produce at least one product comprises the steps of:
i) providing an automated closed-loop control mechanism to autonomously control at least two conditions in, or of, the channel structures, the control mechanism having:—
a sensor for sensing at least one predetermined property of the at least one product,
means for varying said conditions, and
a controller programmed with an algorithm;
ii) setting a range of variation for each of the conditions;
iii) setting a stop condition for the algorithm; and
iv) loading the system with fluids;
   whereby the sensor produces a sensor signal representative of the predetermined property, the controller receives the sensor signal and, by means of the algorithm, causes the means to vary the conditions within the set ranges until the stop condition for the algorithm is fulfilled.

### FIELD OF THE INVENTION

The present invention relates to methods performed on a microfluidic system.

### BACKGROUND OF THE INVENTION

The use of microfluidic systems is now well established in a variety of disciplines, including analytical chemistry, drug discovery, diagnostics, combinatorial synthesis and biotechnology. Such systems also have important applications where sample volumes may be low, as might be the case in the synthesis or screening of combinatorial libraries, in post-genomic characterisations etc.

The microfluidic systems have a microfluidic channel structure of small dimension in which the flow rates of liquids therein are relatively high. This leads to faster and cheaper analysis and/or synthesis within a smaller footprint. A characteristic effect observed in the microfluidic channel structure is the inherently low Reynolds Number (Re<700) which gives rise to laminar flow of the liquid. This effect can be most clearly seen when two flowing streams, from different channels, meet to traverse along a single channel, resulting in the streams flowing side-by-side. The net result of this phenomenon is that there is no turbulence and mass transfer between the two streams takes place by diffusion of molecules across the interfacial boundary layer. The diffusional mixing across this interface can be fast, with times for mixing ranging from milliseconds to seconds. The diffusion mixing time is even shorter if there is reactivity between the flow streams.

The microfluidic channel structure of a microfluidic system may be formed in a microfluidic chip or be formed by a capillary structure.

As background art there may be mentioned EP-A-1 336 432, and Applicant's co-pending International patent application No. PCT/GB2004/001513 which was not published before the priority date of this application and which is hereby incorporated herein by reference.

### SUMMARY OF THE INVENTION

According to the present invention there is provided a method of controlling a system according to claim 1 hereof.

The channel structure may be a flow channel structure in which the fluids are flowable to interact.

Suitably, the fluids react in the channel structure to produce at least one reaction product, i.e. the fluids are reagents. The term “reagent” in this application includes a fluid (e.g. liquid) which contains one or more reagents.

Typically, said variables comprise at least two of: temperature, reaction time, concentration of a first reagent fluid, and concentration of a second reagent fluid. The means for varying the condition in, or of, the channel structure may comprise: a heater, a solvent pump, and a reagent dilutor, respectively.

Typically, the sensor comprises means for analysing said at least one product. The sensor may comprise a LC pump, column and detector.

The microfluidic channel structure may be formed in a microfluidic chip.

Typically, the fluids are injected into the system to form discrete slugs. The system may further comprise a detector to detect said slugs. Typically, the system further includes a valve for diverting the fluids to the sensor, the valve being switched when said detector detects a slug of said at least one product.

The system may further have a transfer mechanism to transfer reagents from an array of reagents to the channel structure. The operation of the transfer mechanism may be controlled by the controller.

Typically, the system further includes the reagent array.

Other aspects and features of the invention are set forth in the claims and the description of exemplary embodiments which now follows.

### BRIEF DESCRIPTION OF THE DRAWINGS

FIG. 1 is a schematic, fragmentary plan view of a prior art microfluidic chip showing its microfluidic channel structure.

FIG. 2 is a schematic, block diagram of a fully integrated system of the invention.

FIG. 3 is a diagram of a two-variable simplex algorithm optimisation.

### DETAILED DESCRIPTION OF THE DRAWINGS

In the following description, like reference numerals are used to denote like features in the different embodiments.

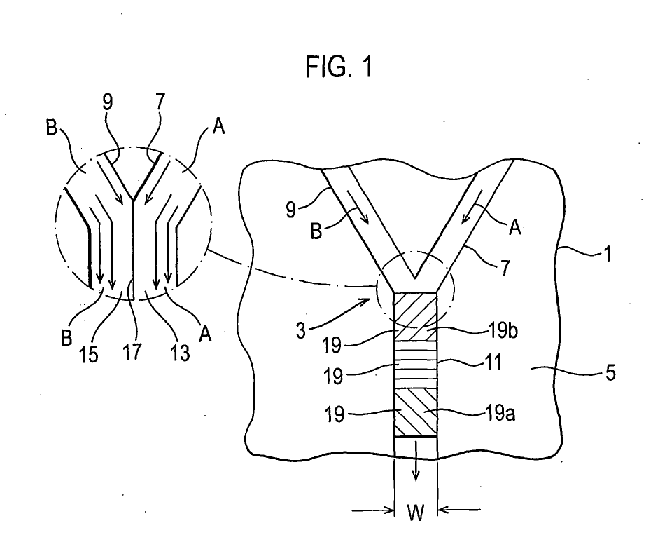

In FIG. 1 there is schematically shown a typical (known) microfluidic chip 1 (also referred to as a micro-reactor) having a Y-shaped microfluidic channel structure 3 provided in an external chip surface 5. The chip 1 is formed from silicon, silica, or glass and the channel structure 3 is provided therein by wet (chemical) or dry (e.g. plasma) etching, as known in the art. The chip 1 could also be formed from a plastics material. Other methods of forming the channel structure 3 are laser micro-machining, injection moulding or hot embossing, as also known in the art.

The channel structure 3 has a pair of inlet branch channels 7, 9 for the concurrent introduction of two reagents A,B into a common flow channel 11. The channels 7, 9, 11 are of dimensions which will enable them to sustain a low Reynolds Number with laminar flow therein at the desired flow rates (Re<700, preferably Re<10). To this end, the channels are preferably of a width W of no more than 300 microns. The depth of the channels 7, 9, 11 is typically no more than the width, and more typically less than the width by 50% or more (i.e. an aspect ratio of width-to-depth of at least 2:1). This is particularly so where flow rates will be less than about 1 ml/s.

The low Reynolds Number in the channel structure 3 results in the reagents A,B following laminarly in the common flow channel 11 in parallel or side-by-side flow streams 13, 15, as shown in the inset of FIG. 1. The net result of this phenomenon is that there is no turbulence and mass transfer between the two flow streams 13, 15 takes place by diffusion of molecules across the interfacial boundary layer 17.

As shown in FIG. 1, the interaction of the reagents in the flow streams 13, 15 results in the generation of reaction products in the fluid as it flows along the common flow channel 11 and the development of a series of “reaction domains” 19, which may be of different colour, for example. The point at which the reaction domains 19 occur relative to the intersection of the inlet branches 7, 9 depends on the reactivity of the reagents. The reaction domains 19 extend across the width of the channel 11, perpendicular to the interface of the flow streams 13,15, and along the length of the channel 11. The reaction domains 19 are most striking when products of one reaction then themselves participate in a subsequent reaction to create reaction domains 19 along the length of the channel 11. If the respective reactions produce products of different colours, then the domains 19 have different colours.

The reaction domains 19 contain different reaction products and correspond to the different stages of the complete reaction of the reagents A,B. In other words, a time resolution of the reaction of A and B is able to be observed in the common flow channel 11. This is due to the different residence times of the reaction domains 19 in the common flow channel 11. In other words, at a given point in time the leading domain 19a has had a longer residence in the common flow channel 11 than the trailing domain 19b. Thus, the interaction between the reactive components of the reagents A,B in the leading domain 19a will have progressed more than in the trailing domain 19b.

Heterogeneous reactions of the aforementioned type can be carried out in different modes. In Mode I, a continuous flow of reagents A,B interact at the point of coincidence of inlet branch channels 7, 9 and attain a steady state in the common flow channel 11 such that the reaction domains 19 appear to be stationary therein. In Mode II, on the other hand, discrete plugs of reagents A,B of short duration are released in the respective inlet branch channels 7, 9 into continuous non-reacting solvent flow streams and react in a heterogeneous manner in the common flow channel 11, as in Mode I, but fail to attain the steady state achieved in Mode I. In Mode III, one of the reagents is pulsed into a continuous non-reacting solvent flow stream whilst a continuous flow stream of the other reagent is provided.

If the carrier liquids or reagents are immiscible, different reaction domains can be formed in different phases.

As an example of steady state Mode I, consider the case where reagent A is aqueous potassium permanganate and reagent B is an alkaline aqueous ethanol solution. The reaction domains 19 are of different characteristic colours which correspond to those known for the stepwise reduction of the potassium permanganate with the alkaline ethanol.

As an example of Mode II, a plug of benzyl phosphonium bromide (reagent A) is released into a non-reacting continuous solvent flow stream in one of the inlet branch channels 7 (e.g. methanol) while a plug of a mixture of aryl aldehyde and a base, e.g. sodium methoxide, (reagent B) is released into a non-reacting continuous solvent flow stream (e.g. methanol) in the other inlet branch channel 9. This results in a heterogeneous reaction in the common flow channel which emits a plug of the stilbene reaction product.

An example of Mode III is a Suzuki reaction in which variable plugs of an aryl halide are released into a continuous flow stream of an aryl boronic acid within a catalysis-lined common flow channel 11.

As will be appreciated, the inlet branch channels 7, 9 could form other shapes with the common flow channel 11 instead of the Y-shape, for instance a T-shape.

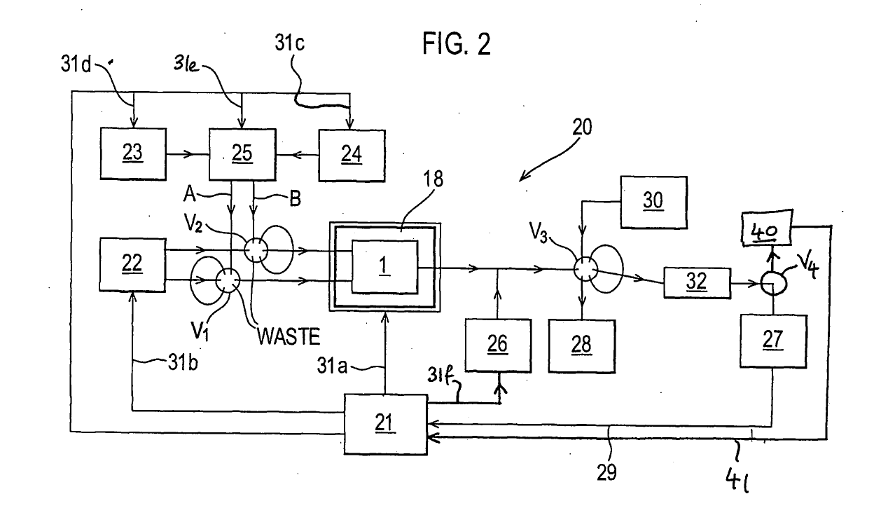

A computer-controlled system 20 of the present invention incorporating the microfluidic chip 1 is shown schematically in FIG. 2. The system is controlled by a computer 21 which is operatively coupled to the microfluidic chip 1. The computer 21 is of a standard PC format running a Windows® operating system (Microsoft Corporation, USA) with a Pentium® 4 processor (Intel Corporation, USA).

A heater 18 is operatively coupled to the chip 1 for heating thereof.

The system further includes a solvent pump 22 and valves V₁ and V₂. The valves are 6-port micro-bore valves with vertical port injection from VICI controlled through a National Instrument card (NI-card). The solvent pump 22 generates a stream of solvent under the control of the valves V₁ and V₂. The solvent pump 22 is a 4-channel Nanoflow pump from Eksigent which is controlled through a serial port.

The system 20 further comprises a reagent library 23, which may have only two reagents or a greater number of reagents, depending on the process to be carried out on the system 20. Where the reagent library 23 contains a large number of different reagents, the library takes the form of a categorised reagent array, such as described by Caliper Technologies Corporation (California, USA) as “LibraryCard”. As an alternative, the reagents in the categorised reagent may be in tubes or the wells of one or more plates (e.g. microtitre plate(s)).

The reagent library 23 is operatively coupled to the microfluidic chip 1 through a transfer mechanism 25, via the valves V₁ and V₂. The transfer mechanism 25 is a HTS PAL Autosampler from CTC Analytics, controlled through a serial port. However, the transfer mechanism 25 may take other forms known in the art. Optionally, the reagent transfer mechanism 25 is operatively connected to the computer 21 and controlled by a signal 31e therefrom. This is illustrated in FIG. 2.

The reagents (A, B) are carried with the solvent under the control of the valves V₁ and V₂ and as described above with reference to Modes I, II and III.

Also operatively coupled to the transfer mechanism 25 is a dilutor 24. The dilutor 24 is capable of diluting the reagents (A, B) independently of each other, in order to control the concentration of the reagents (A, B) passing to the transfer mechanism 25 and hence into the chip 1. The dilutor 24 is a dual-syringe dilutor, 531C, PC controlled from Hamilton, controlled through a serial port and a contact closure.

A dilution pump 26 (Jasco PU1585) is provided to dilute the reaction product that is produced in the chip 1. The dilution step stops the reaction and ensures that the reaction product is at a concentration that is suitable for analysis, as will be described below. The dilution pump may be controlled by a signal 31f from the computer 21.

An UV detector 28 is provided downstream of the dilution pump 26 to detect the presence of reaction product. In particular, the UV detector 28 is adapted to detect the presence of a slug of reaction product. The UV detector 28 is a Jasco UV2075 Plus equipped with a micro-flow cell and data acquisition is through a NI-card

When reaction product is detected, a valve V₃ (same type as above) that is provided downstream of the dilution pump 26 is switched to direct the reaction product to a sensor 27.

On switching the valve V₃, a flow path is opened between a liquid chromatograph (LC) pump 30 and a LC column 32, whereby mobile phase from the LC pump 30 carries the reaction product to the LC column 32. The LC pump takes the form of two Jasco PU1585 pumps equipped with a degasser DG1580-53 and a dynamic mixer HG1580-32, controlled through a Jasco LC Net II/ADC box. The LC column is a Zorbax SB C18 (Agilent), with 3.5 micron particles.

The compounds (starting material, product and by-products) within the reaction product are separated in the LC column 32 in a known manner. Once separated, the compounds are conveyed through a valve V₄ for detection by a sensor 27. The sensor 27 is a mass spectrometer (MS) and/or another detector(s), e.g. a UV sensor and/or a diode array, as known in the art. The sensor 27 in this embodiment is comprised of a Jasco UV1570M equipped with a semi-micro-flow-cell with data acquisition through a Jasco LC Net II/ADC box and a Waters Micromass ZQ with data acquisition and control through a Network card.

The valve V₄ at this point is not open to a bio-sensor 40, more details of which follow hereinafter.

The resultant raw detected data is then analysed and the sensor 27 produces a sensor signal 29 which is representative of a predetermined property of the reaction product(s) and feeds this back to the computer 21 for processing thereof. The predetermined property may be purity and/or molecular weight or identity and/or yield of the reaction product(s).

Depending on the sensor signal 29, the valve V₄ may be operated to allow for the reaction product(s) to also be conveyed to the bio-sensor 40 with the bio-sensor 40 sending a sensor signal 41 to the computer 21 representative of the bio-sensor result for the reaction product(s). As an example, the reaction product(s), or one of the reaction products, would be sent to the bio-sensor 40 if the sensor signal 29 was indicative that a compound was detected by the sensor 27 that was worthwhile sending to the bio-sensor 40 for analysis.

Typically, as here, the bio-sensor signal 41 will be representative of a biological property of the reaction product(s), depending on the nature of the bio-sensor. The bio-sensor may be any bio-assay known in the art, for example a kinase-inhibitor assay. In this particular embodiment, the bio-sensor signal 41, when generated, is used by the computer to determine what the demand signal 31 should be. Otherwise, it is the chemical sensor signal 29.

It will be appreciated that this serial approach to the analysis of the reaction product(s), i.e. chemical sensor 27 followed by the bio-sensor 40, could be replaced with a parallel approach, i.e. the reaction product(s) are sent to the sensors 27, 40 at the same time.

It will further be appreciated that the system 20 could be constructed with just one of the sensors 27, 40.

As described in more detail hereinafter, the computer utilises an iterative Simplex algorithm to cause the system 20 to operate to produce, or attempt to produce:—

(i) an optimisation of reaction conditions in the microfluidic channel structure 3, for example to optimise yield or produce a specific outcome, or
(ii) a reaction product in which a predetermined property is sensed by the sensor 27, 40 or is sensed to be of a predetermined value.

In this regard, the computer 21 and sensors 27, 40 are comprised in an automated, real-time closed-loop control (or feedback loop control) of the system 20. By way of explanation, the real-time sensor signal 29, 41 is processed by the computer 21 and results in a demand signal 31 being output which is responsive to the sensor signal 29, 41. The demand signal 31 is used to cause a change in a condition in and/or of the chip channel structure 3.

More particularly, the demand signal 31 may be used to vary the conditions experienced by the reagents (A, B) in the chip channel structure 3, for instance flow rate, temperature, pressure, . . . etc. Demand signal 31a controls the heater 18, thereby controlling the temperature of the chip 1 and hence the temperature at which the reaction takes place. Demand signal 31b controls the solvent pump 22, thereby controlling, independently, the rate of flow of the reagents (A, B) through the chip 1 and hence the reaction time.

Alternatively, or additionally, the condition of the reagents themselves may be varied. Demand signal 31c controls the dilutor 24, hence controlling the concentration of one or both of the reagents (A, B). Demand signal 31d may be used to change one or more of the reagents transferred from the library 23 to the microfluidic chip 1. In the latter case, the method of selecting a replacement reagent by the algorithm will be facilitated by the categorisation applied to the reagent library 23 (which categorisation will be programmed in the computer) such that the algorithm is able to select the reagent which most closely resembles the reagent it predicts to be necessary from a most suitable search.

The system 20 thus appears to “intelligently” and heuristically vary the parameters of the reaction in the chip 1 so as to seek to obtain the goal or multiple goals of the algorithm, e.g. an optimisation of one or more properties of the reaction product. To this end, the computer 21 uses a Simplex algorithm with the sensor signals 29, 41 as an input and with the demand signal 31 as an output.

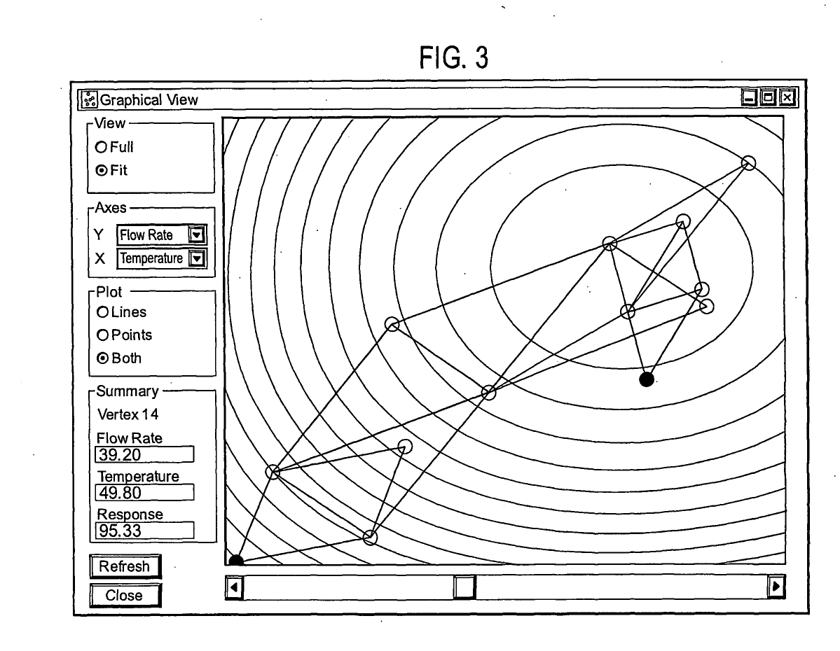

The application of Simplex-algorithms is known and will not be described here in detail. A preferred algorithm is the modified simplex technique that was proposed by Nelder and Mead. A simplex is a geometric Figure having a number of vertices (or corners), each one corresponding to a set of experimental conditions. Depending on the outcome of the experiment, the simplex is geometrically moved (reflected, shrunk or expanded). For a two-factor experiment, the simplex is a triangle. One can imagine the triangle being flipped from the lowest point through the best vertice—the next-best vertice, repeatedly to find the maxima. An example of such an iteration is shown in FIG. 3.

The algorithm is a “black-box” for the user. Standard optimisation protocol doesn't require the user to set any parameter apart from the range for each variable. Because of the way the platform was built, the algorithm can easily be changed (for an improved version or another type of algorithm).

In the system 20, the laboratory component parts are scheduled and actuated by a standard laboratory software program stored on the computer 21, in this embodiment a “Labview 7.0” system control program, which depends on the algorithm output for its function. For ease of reference, FIG. 2 only shows the main input and output signals associated with the algorithm.

In normal operation mode, the user needs to perform the following tasks:
1. Choose which variables to optimise (minimum of 2 to choose between, for example, the temperature, the reaction time, the concentration of reagent A and the concentration of reagent B), set the range for each of them and the stop condition for the algorithm;
2. Load a solution of each reagent A,B (or mixture of reagents) with a concentration equal to the higher concentration of the considered range (or a chosen concentration if that variable doesn't need to be optimised);
3. Set up the analytical part of the system (choose a LC method and a data analysis method, enter data for the product). It is possible to take into account a by-product that has to be avoided when calculating the response (and then for example optimise only one isomer).

The system then performs the following actions (without the user's intervention):
1. The computer 21 gets the reaction conditions for the reaction to perform from the algorithm and sends the information to each equipment (solvent pump 22, heater 18 and dilutor 24) that take the appropriate action (change the flow rate, the temperature and/or dilutes part of the stock solution).
2. The transfer mechanism 25 injects the reagents at the right concentration into the valves V₁ and V₂;
3. The valves V₁ and V₂ switch and hence the two reagents A,B are injected in the system. They progress to the chip 1 where the reaction takes place at the pre-set temperature;
4. When leaving the chip 1, the reaction mixture is diluted by the dilution pump 26 to stop the reaction and to be at the right concentration for the analytical part of the process.
5. The computer 21 monitors the signal from UV detector 28 for detecting the slug of reaction mixture. When it is detected, the loop on valve V₃ is full of diluted reaction mixture;
6. The valve V₃ switches to analyse the reaction mixture (the sample goes through the LC column 32, being pushed by a gradient of mobile phase coming from the LC pump 30). The compounds (starting material, product and by-products) are separated and detected by the sensor 27;
7. The raw data is then analysed by the computer program that controls the separation process (Masslynx 4.0) and the result is sent (similar to a conversion) to the algorithm that either answers with a set of conditions for the next experiment to perform or first sends the compound(s) to the bio-sensor 40 so as to receive the bio-sensor signal 40 whereupon the new set of conditions are generated responsive thereto; and
8. The process starts again from step 1 till the stop condition for the algorithm is fulfilled.

At the end of the process a report containing the list of all the performed experiments, including the value for each variable and the associated response may be generated.

It will seen that in the described embodiment optimisation is achieved by performing a multi-parametric search using the Simplex algorithm based on input from one or more sensors.

It will be understood that the chemical sensor could be embodied as a plurality of chemical sensor members, either operating in series or parallel, and the bio-sensor could be embodied as a plurality of serially- or parallel-arranged bio-sensor members (bio-assays) to give the algorithm multiple chemical sensor input signals and/or multiple bio-sensor input signals. The algorithm then issues the new output signal 31 taking account of all of the sensor signals produced.

It will be further understood that the micro-reactor 1 may be such as to allow the use of more than two reagents/reagent mixtures. In this connection, the micro-reactor 1 may take the form of that shown in FIG. 3 of International patent application No. PCT/GB2004/001513 supra.

It will be understood that the present invention is not limited to the specific embodiments hereinabove described, but may take on many other guises, forms and modifications within the scope of the appended claims. As an example, the channel structures described with reference to FIGS. 1 to 3 could be formed by a capillary network instead of in a chip. As another example, the chemical sensor need not be a liquid chromatography mass spectrometer, but may be any suitable chemical sensor, in which case a LC pump and LC column might not be appropriate and would be replaced by suitable means. There is no need to detect slugs of reaction product. Where these are detected, the detector need not be an UV detector. It is also to be noted that the specific embodiment may incorporate previously unspecified features which are set forth in the claims, such as the user interface.

For the avoidance of doubt, the use of reference numerals in the accompanying set of claims is purely for illustration and thus not to be taken as having a limiting effect.

What is claimed is:

1. A method of controlling a system having a microfluidic channel structure in which fluids are able to interact to produce at least one product, comprising the steps of:
i) providing an automated closed-loop control mechanism to autonomously control at least two conditions in, or of, the channel structure, the control mechanism having:
a sensor for sensing at least one predetermined property of the at least one product,
means for varying said conditions, and
a controller programmed with an algorithm;
ii) setting a range of variation for each of the conditions;
iii) setting a stop condition for the algorithm; and
iv) loading the system with fluids;
whereby the sensor produces a sensor signal representative of the at least one predetermined property, the controller receives the sensor signal and, by means of the algorithm, causes the means to vary the conditions within the set ranges until the stop condition for the algorithm is fulfilled.

2. The method of claim 1, wherein said variables comprise at least two of: temperature, reaction time, concentration of a first reagent fluid, and concentration of a second reagent fluid.

3. The method of claim 2, wherein the means for varying the condition in, or of, the channel structure comprises a temperature controller for varying the temperature of the fluids in the channel structure and/or a flow rate controller for varying the flow rate of the fluids in the channel structure and/or a concentration controller for varying the concentration of the reagents in the channel structure.

4. The method of claim 1, wherein the sensor comprises means for analysing said at least one product.

5. The method of claim 4, wherein the sensor comprises a liquid chromatography mass spectrometer.

6. The method of claim 1, wherein the microfluidic channel structure is formed in a microfluidic chip.

7. The method of claim 1, wherein the fluids are injected into the system to form discrete slugs of the at least one product and wherein the system further comprises a detector to detect said slugs.

8. The method of claim 1, wherein the system further includes a valve which is selectively opened to allow the at least one product to pass to the sensor when a detector detects said at least one product at a location upstream of, or in, the valve.

9. The method of claim 1, wherein the system further comprises a transfer mechanism to transfer reagents from an array of reagents to the channel structure.

10. The method of claim 9 in which the operation of the transfer mechanism is controlled by the controller in dependence of the sensor signal.

11. The method of claim 1 in which the sensor is selected from the group consisting of a chemical sensor, a bio-sensor, and both a chemical sensor and a bio-sensor.

12. The method of claim 1 in which the at least one predetermined property is dependent on said conditions.

13. The method of claim 1 in which the stop condition is based on attainment of a requirement for the at least one predetermined property of the at least one product and the conditions are varied in their set ranges to search for the combination of the conditions which attains the requirement.

14. The method of claim 13 in which the stop condition is fulfilled when a predetermined number of condition combinations are found that attain the requirement, for instance the first condition combination which is found.

15. The method of claim 13 in which the stop condition is fulfilled when no condition combination resulting in attainment of the requirement is found by a complete search in the respective ranges of the conditions.

16. The method of claim 1 in which the system has a user interface through which a user of the system inputs the conditions to be varied and sets the ranges therefor.

17. The method of claim 16 in which the user interface comprises a manual input device for the user to input the conditions and the set ranges, for example a keyboard.

18. The method of claim 1 in which the system is a fully-integrated system autonomously controlled by the controller.
